(19) United States
(12) Patent Application Publication
(10) Pub. No.: US 2003/0041383 A1
(43) Pub. Date: Mar. 6, 2003

(54) Wrench structure

(76) Inventor: Chin Shun Cheng, Taichung (TW)

Correspondence Address: CHIN SHUN CHENG, No.1, Alley 16, Lane 40,, Jinn Te Road, Taichung, TW

(21) Appl. No.: 09/945,466

(22) Filed: Sep. 4, 2001

(51) Int. Cl. B25B 13/00

(52) U.S. Cl. 7/138

(57) ABSTRACT

A wrench structure primarily includes a wrench body, and a magnetic telescopic bar selectively secured in a proper position of the wrench body. In such a manner, the magnetic telescopic bar is entirely hidden in the wrench body when not in use without occupy any space, and can be pulled outward from the wrench body when in use to attract a small workpiece made of metallic material disposed in a narrow space.

### BACKGROUND OF THE INVENTION

1. Field of the Invention

The present invention relates to a wrench structure, and more particularly to a wrench structure that can be used to attract a small workpiece in a narrow space, thereby facilitating the operator using the wrench structure to operate the workpiece.

2. Description of the Related Art

A conventional socket wrench in accordance with the prior art comprises a wrench body having one end formed with a drive head which is provided with a square socket drive stub. In operation, the socket drive stub of the drive head of the wrench body may be inserted into a socket which is fitted on a workpiece such as a screw, a nut or the like, so that the wrench body can co-operate with the socket to operate and rotate the workpiece. However, the workpiece is easily detached from the socket during rotation. If the workpiece unintentionally falls into an elongated narrow space, the operator needs to use an elongated bar to take the workpiece out of the elongated narrow space, thereby causing inconvenience in operation.

### SUMMARY OF THE INVENTION

The present invention has arisen to mitigate and/or obviate the disadvantage of the conventional socket wrench.

The primary objective of the present invention is to provide a wrench structure including a magnetic telescopic bar which is entirely hidden in the wrench body when not in use without occupy any space, thereby saving the space of the wrench structure.

Another objective of the present invention is to provide a wrench structure including a magnetic telescopic bar which can be pulled outward from the wrench body when in use to attract a small workpiece made of metallic material in a narrow space, thereby facilitating the operator using the wrench structure to operate the workpiece.

In accordance with the present invention, there is provided a wrench structure, comprising:

a wrench body; and

a magnetic telescopic bar selectively secured in a proper position of the wrench body;

wherein, the magnetic telescopic bar is entirely hidden in the wrench body when not in use, and is pulled outward from the wrench body when in use to attract a small workpiece made of metallic material.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a wrench structure in accordance with a first embodiment of the present invention;

FIG. 2 is a perspective view of a magnetic telescopic bar of the wrench structure as shown in FIG. 1;

FIG. 3 is a schematic operational view of the wrench structure as shown in FIG. 1 in use;

FIG. 4 is an exploded perspective view of the wrench structure as shown in FIG. 1;

FIG. 5 is an exploded perspective view of a wrench structure in accordance with a second embodiment of the present invention;

FIG. 6 is a schematic operational view of the wrench structure as shown in FIG. 5 in use;

FIG. 7 is an exploded perspective view of a wrench structure in accordance with a third embodiment of the present invention;

FIG. 8 is a perspective assembly view of the wrench structure as shown in FIG. 7; and

FIG. 9 is a schematic operational view of the wrench structure as shown in FIG. 8 in use.

### DETAILED DESCRIPTION OF THE INVENTION

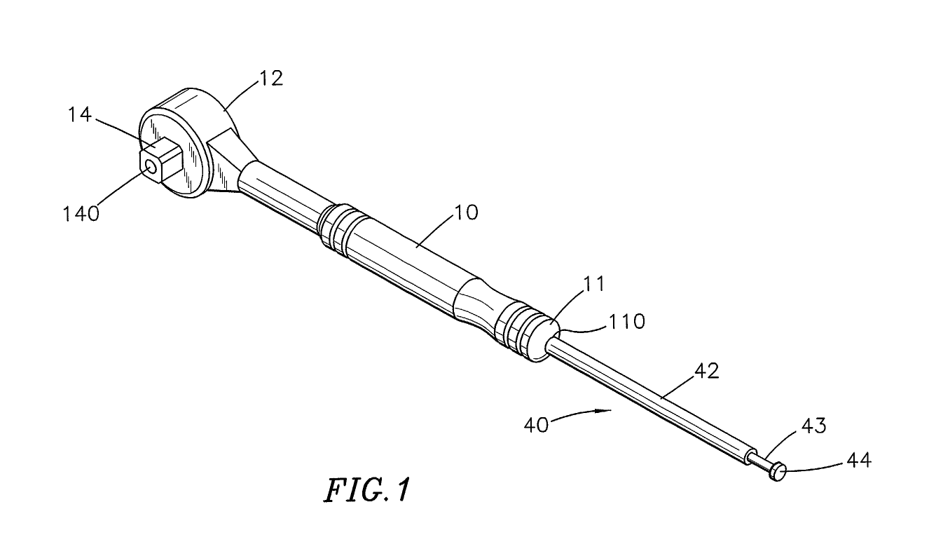

Referring to the drawings and initially to FIGS. 1-3, a wrench structure in accordance with a first embodiment of the present invention comprises a wrench body 10, and a magnetic telescopic bar 40.

The wrench body 10 has a first end formed with a drive head 12, and a second end formed with a receiving seat 11. The drive head 12 of the wrench body 10 is provided with a square socket drive stub 14 defining a receiving chamber 140 therein. The receiving seat 11 of the wrench body 10 also defines a receiving chamber 11 therein.

The magnetic telescopic bar 40 is secured in the receiving seat 11 of the wrench body 10, and includes an outer tube 41 secured in the receiving chamber 110 of the receiving seat 11 of the wrench body 10, a first inner tube 42 retractably mounted in the outer tube 41, a second inner tube 43 retractably mounted in the first inner tube 42, and a magnetic block 44 secured on the distal end of the second inner tube 43.

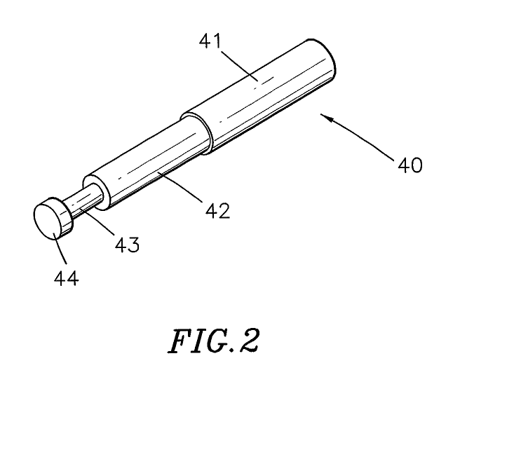

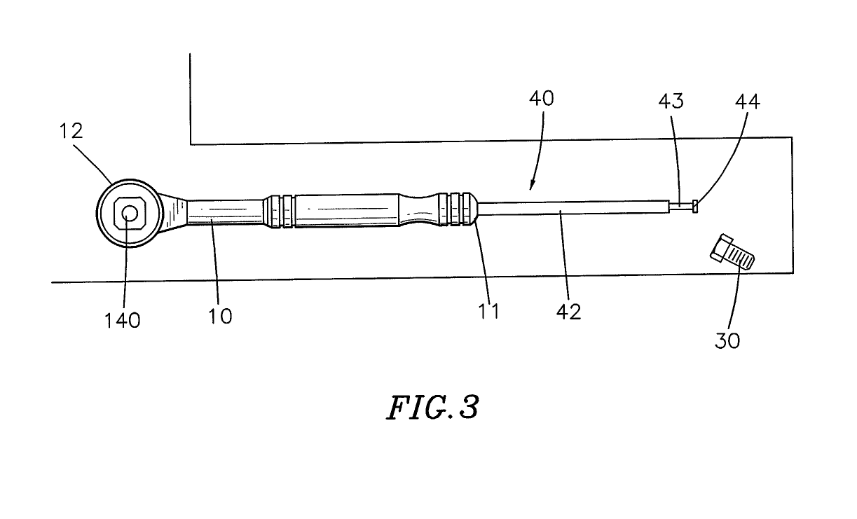

In operation, referring to FIG. 3 with reference to FIGS. 1 and 2, the socket drive stub 14 of the drive head 12 of the wrench body 10 is inserted into a socket (not shown) which is fitted on a workpiece 30 made of metallic material such as a screw, a nut or the like, so that the wrench body 10 can co-operate with the socket to rotate the workpiece 30.

The magnetic telescopic bar 40 is initially hidden in the receiving seat 11 of the wrench body 10 when not in use. In use, if the workpiece 30 is unintentionally detached from the socket and falls into a narrow space as shown in FIG. 3, the inner tubes 42 and 43 of the magnetic telescopic bar 40 can be pulled outward from the receiving seat 11 of the wrench body 10 quickly and easily, so that the magnetic block 44 of the magnetic telescopic bar 40 can be extended into the narrow space to attract the workpiece 30 by the magnetic force of the magnetic block 44 of the magnetic telescopic bar 40, thereby drawing and taking the workpiece 30 out of the narrow space without needing the aid of other tools.

The magnetic telescopic bar 40 is entirely hidden in the receiving seat 11 of the wrench body 10 when not in use, so that the magnetic telescopic bar 40 does not occupy any space, thereby facilitating operation of the wrench structure of the present invention.

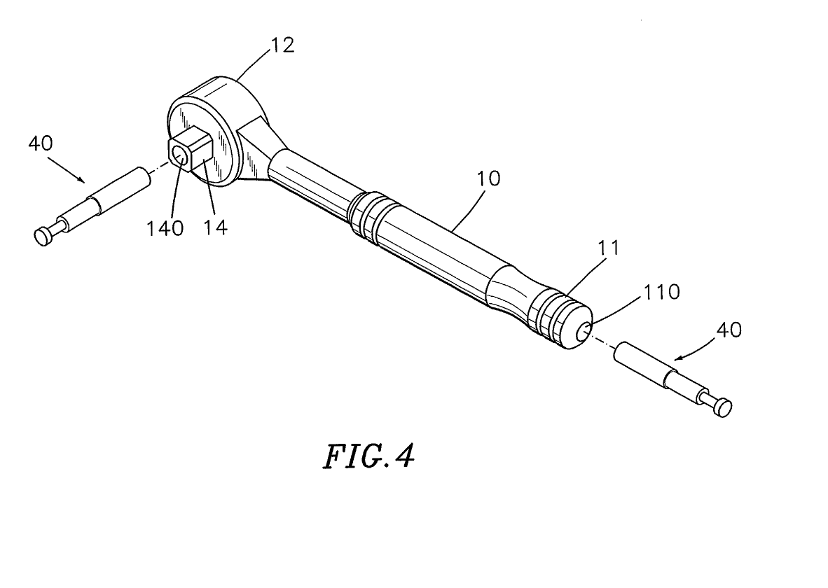

Referring to FIG. 4, the magnetic telescopic bar 40 may be secured in the receiving chamber 140 of the socket drive stub 14 of the drive head 12 of the wrench body 10. Thus, when the socket drive stub 14 of the drive head 12 of the wrench body 10 is inserted into the socket, and the socket is fitted on the workpiece 30, the workpiece 30 can be temporarily retained in the socket by the magnetic force of the magnetic block 44 of the magnetic telescopic bar 40.

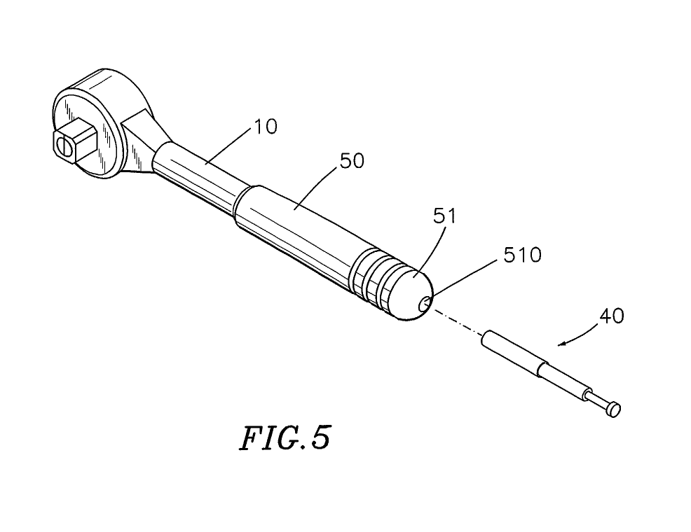

Referring to FIG. 5, in accordance with a second embodiment of the present invention, the wrench body 10 is provided with a handle 50 formed with a receiving seat 51 defining a receiving chamber 510 for receiving and securing the magnetic telescopic bar 40 therein.

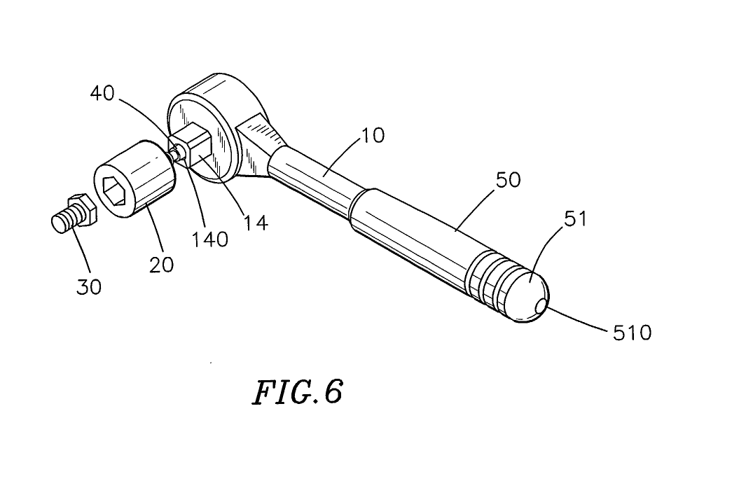

Referring to FIG. 6, the magnetic telescopic bar 40 may be secured in the receiving chamber 140 of the socket drive stub 14 of the drive head 12 of the wrench body 10. Thus, when the socket drive stub 14 of the drive head 12 of the wrench body 10 is inserted into the socket 20, and the socket 20 is fitted on the workpiece 30, the workpiece 30 can be temporarily retained in the socket 20 by the magnetic force of the magnetic block 44 of the magnetic telescopic bar 40.

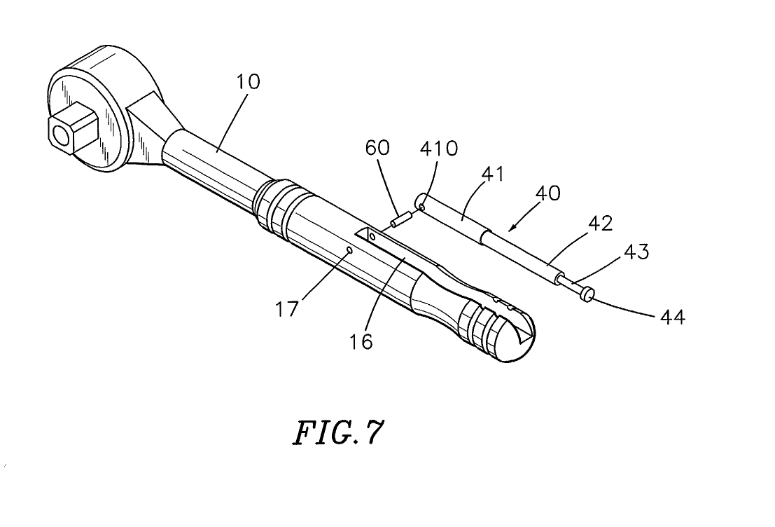

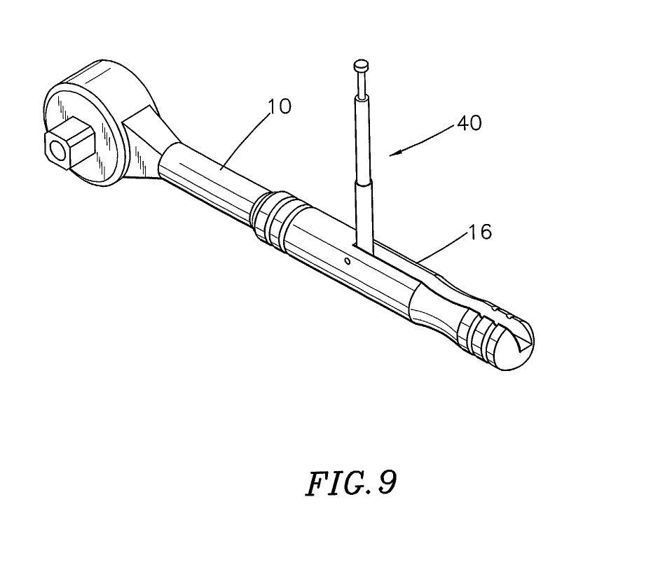

Referring to FIGS. 7-9, in accordance with a third embodiment of the present invention, the second end of the wrench body 10 is directly formed with an elongated receiving chamber 16 for receiving the magnetic telescopic bar 40 therein. A pivot pin 60 is extended through a through hole 17 defined in the second end of the wrench body 10, and through a pivot hole 410 defined in the outer tube 41 of the magnetic telescopic bar 40, so that the magnetic telescopic bar 40 is pivoted in the elongated receiving chamber of the wrench body 10.

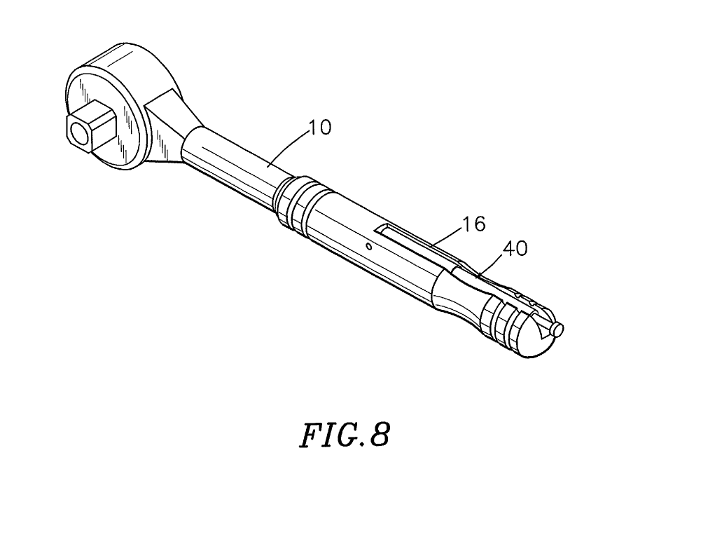

The magnetic telescopic bar 40 is initially hidden in the elongated receiving chamber 16 of the wrench body 10 as shown in FIG. 8 when not in use. In use, the magnetic telescopic bar 40 may be pivoted about the pivot pin 60 to protrude outward from the elongated receiving chamber of the wrench body 10 to attract the workpiece.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench structure, comprising:
a wrench body; and
a magnetic telescopic bar selectively secured in a proper position of said wrench body;
wherein, said magnetic telescopic bar is entirely hidden in said wrench body when not in use, and is pulled outward from said wrench body when in use to attract a small workpiece made of metallic material.

2. The wrench structure in accordance with claim 1, wherein said wrench body is formed with a receiving seat defining a receiving chamber for securing said magnetic telescopic bar therein.

3. The wrench structure in accordance with claim 1, wherein said wrench body includes a drive head formed with a socket drive head defining a receiving chamber for securing said magnetic telescopic bar therein.

4. The wrench structure in accordance with claim 1, wherein said wrench body includes a handle formed with a receiving seat defining a receiving chamber for securing said magnetic telescopic bar therein.

5. The wrench structure in accordance with claim 1, wherein said wrench body is formed with an elongated receiving chamber for receiving said magnetic telescopic bar therein.

6. The wrench structure in accordance with claim 5, wherein said wrench body defines a through hole communicating with said receiving chamber, said magnetic telescopic bar defines a pivot hole, and said wrench body further comprises a pivot pin in turn extended through said through hole of said wrench body and through said pivot hole of said magnetic telescopic bar, so that said magnetic telescopic bar is pivoted in said receiving chamber of said wrench body.

7. The wrench structure in accordance with claim 1, wherein said magnetic telescopic bar includes an outer tube secured in said wrench body, at least one inner tube retractably mounted in said outer tube, and a magnetic block secured on a distal end of said at least one inner tube.
